(19) United States
(12) Patent Application Publication
(10) Pub. No.: US 2002/0004799 A1
(43) Pub. Date: Jan. 10, 2002

(54) High availability database system using live/load database copies

(76) Inventors: Alexander Gorelik, Fremont, CA (US); Leon Burda, Cupertino, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/782,178

(22) Filed: Feb. 12, 2001

Related U.S. Application Data
(60) Provisional application No. 60/182,087, filed on Feb. 11, 2000.

(51) Int. Cl. G06F 17/30

(52) U.S. Cl. 707/201; 707/10

(57) ABSTRACT

In a computing system, wherein applications access databases to obtain data and the databases are updated from time to time and the applications require consistent data from the databases even while an update is occurring, a first database; a second database, wherein the first database and second database a substantive copies of each other outside of an update period; a database indicator that indicates one of the first and second databases as a live database and the other one of the first and second databases as a load database; a query router for routing queries from application to the live database; and a router switcher for switching the database indicator such that the live database becomes the load database and the load database becomes the live database.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### BACKGROUND OF THE INVENTION

The present invention relates to the field of database management systems, and more particularly to methods and apparatus for providing a consistent version of a database to applications while the database is being loaded.

Many mission critical systems today require continuous (24 hours/day, seven days/week, etc.) availability from databases that hold the data needed by the systems. These databases often contain dynamic information that changes from time to time. To update a database, a periodic load operation is performed. The typical load operation creates issues of availability, consistency and performance.

During the load operation, the tables of the database that are being loaded with updates are typically unavailable for reading during that time. Some approaches to the problem of table unavailability provide less than optimal solutions. One method that has been tried is the use of special isolation levels (see, for example, U.S. Pat. No. 5,870,758 issued to Bamford et al. and entitled “Method and Apparatus for Providing Isolation Levels in a Database System”). Unfortunately, the special isolation level approach is not available for all databases and may significantly aversely affect the overall performance of the system.

Another method that has been tried is transactional replication, where updates are applied in small, internally consistent transactions (see, for example, U.S. Pat. No. 5,170,480 issued to Mohan, and entitled “Concurrently Applying Redo Records to Backup Database in a Log Sequence Using Single Queue Server Per Queue At A Time”. This approach is only practical if the updates can be extracted from the source systems as complete, consistent transactions. Unfortunately, that is not possible for most systems. Furthermore, this approach typically requires that a target database look like the source database—which is typically not the case.

Yet another, popular, approach is the use of small transactions, where partial data is loaded in small transactions (e.g., one transaction for every 1000 rows). The approach might result in consistency problems. While the data is being updated as a series of small transactions, the database is in an inconsistent state and may return erroneous results. Furthermore, if the loading fails for any reason, the database may remain in the inconsistent state for a prolonged period of time.

In addition to the availability and consistency problems of the above approaches, they also might cause performance problems. While the database is being loaded, the performance of the applications using the database could be significantly affected because the database server, its memory caches and disk would be busy loading the data.

### SUMMARY OF THE INVENTION

Embodiments of the present invention overcome the drawbacks of the prior art, by a system maintaining two copies of a database to be accessed by the system's applications. While one copy of the database (the “live” database) is used by the applications, the other database (the “load” database) is loaded. When the loading is completed, the applications switch to using the newly loaded database (i.e., the load database becomes the live database and vice versa), while the other database is loaded.

Aspects of the invention provide a method for providing consistent information from a database management system comprising a plurality of databases, including a method for receiving a request for a first information item by said database management system, processing the request by a first database, when the request is for a read operation, and processing the request by a second database, when said request is for a write/load operation.

The databases can be loaded with data without affecting the performance, availability or consistency of the data to the applications using the database. Methods are provided for switching between the two databases and keeping them consistent.

Embodiments of the present invention also provide methods for directing requests from applications to the live database and for directing requests for loading information to the load database.

A further understanding of the nature and the advantages of the inventions disclosed herein may be realized by reference to the remaining portions of the specification and the attached drawings.

### BRIEF DESCRIPTION OF THE DRAWINGS

FIG. 1 is a block diagram of a high availability system according to one embodiment of the present invention.

FIG. 2 illustrates a variation of the system shown in FIG. 1 wherein applications use a connection router to hook to a database designated as the live database and presents queries to the hooked database directly.

FIG. 3 illustrates an update apparatus and method including an update buffer where updates to the load database are buffered for later updating of the live database.

FIG. 4 is a series of block diagrams illustrating a cycle of states for a live/load database system.

FIG. 5 is a block diagram of a variation of the system in FIG. 1, where control tables are used to signal live/load status of the databases holding such control tables.

FIG. 6 is a partial block diagram of a system similar to that of FIG. 1, but wherein applications may issue writes to the databases.

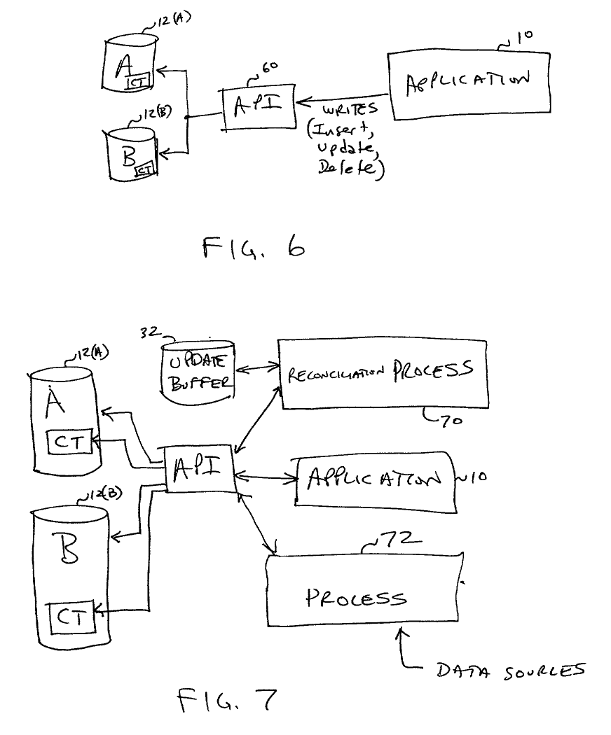

Fig, 7 is a partial block diagram of the system of FIG. 6, illustrating a reconciliation and update processes for when both an application and an update process update a load database.

Appendix A is a source code listing of a sample SQL file used to buffer SQL.

### DESCRIPTION OF THE SPECIFIC EMBODIMENTS

A specific embodiment typically provides consistent access to a logical database system. Consistent access refers to the ability of an application to read and write/load data at the same time from the logical database system without the application combining outdated data with more recent data that would result in inconsistencies in the data presented to the application.

FIG. 1 illustrates a database management system wherein consistent, continuous access is provided to an application even if the database is periodically updated. As shown, application(s) 10 issue query requests (or other read-only accesses) to a database 12, which is implemented as two databases, referenced as database 12(A) (“DB A”) and database 12(B) (“DB B”). One of the two databases 12 is designated the live database and the other is designated the load database. A control manager 18 indicates to an update router 16 and a query router 14 which of the databases is the live database and which is the load database.

As shown in FIG. 1, DB A is the live database and fields queries from applications, while DB B is the load database and receives updates from data sources or other update processes or mechanisms. In due course, control manager 18 switches the designations. If the system were in the state shown in FIG. 1, when control manager 18 switches the designations, then DB A would be the load database and DB B would be the live database. As described below, the system might be designed with intermediate states to facilitate consistent, continuous responses.

Query router 14 routes query requests to the live database, so an application need not be aware of which database is the live database or even be aware that a live/load system is being used. Update router 16 routes updates to the load database and update sources might or might not be aware that a live/load system is being used.

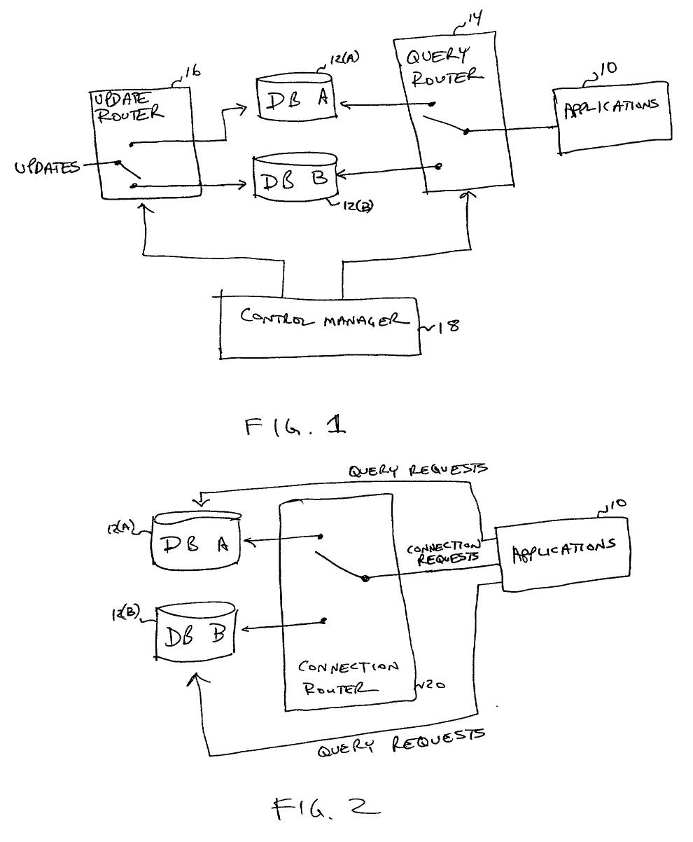

FIG. 2 illustrates a variation of the basic system, wherein a connection router 20 is used to route database connections when an application seeks to establish a connection to a database to perform a query. Unlike the system shown in FIG. 1, once the application opens a connection via connection router 20, the queries themselves are directed directly to the opened database. While some arrows representing data flows are depicted in the figures as being unidirectional, it should be understood that the connections could be bidirectional, although the main intent of data flowing is to send data in the direction of the unidirectional arrows.

Referring again to FIG. 2, checking a live/load status of a database can take time and use resources, so checking only when the connection is initiated is efficient, although that might create a requirement for a delay between the switching of a database to “load” status and loading updates, to allow queries to complete if the queries have connections open.

A query application might use an API to access the live/load database. When the application is ready to connect to the database and apply a query, it calls the API to determine which database to query (i.e., which database is “live”) and the connection information required to connect to that database. The API returns a key value used to return the connection information.

FIG. 3 illustrates the update process and apparatus in more detail. As shown there, an update manager 30 handles the updating of the load database. The updates might be refresher delta updates expressible by SQL statements.

In addition to applying the updates to the load database, update manager 30 stores the updates in an update buffer 32. When control manager 18 switches the databases, update manager 30 then applies the buffered updates to the database that was the live database, but would then be the load database. Where the data source knows to apply the updates to two databases at different times, update manager 30 and update buffer 32 might not be needed. However, if update manager 30 and update buffer 32 are used, then the source of updates need not be aware that a live/load system is in use.

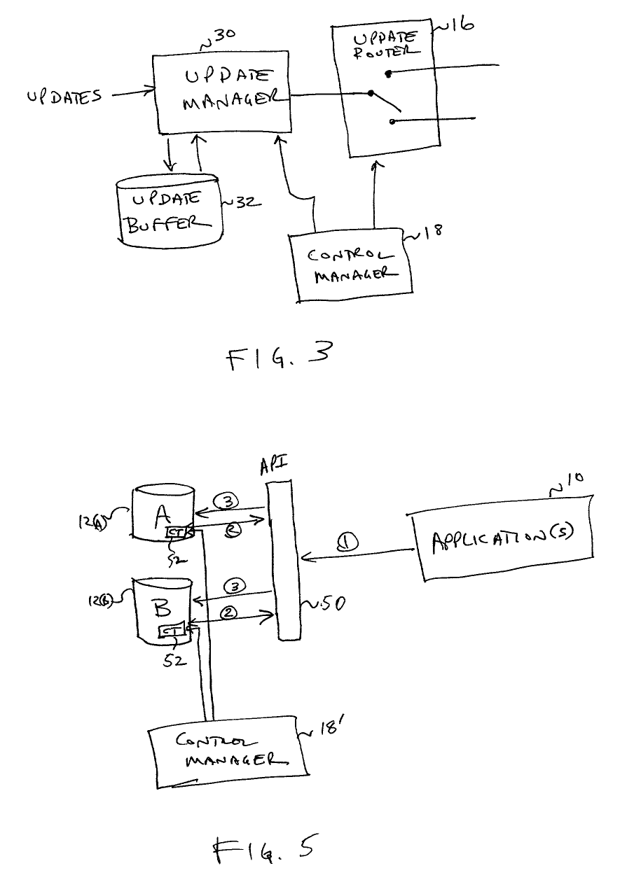

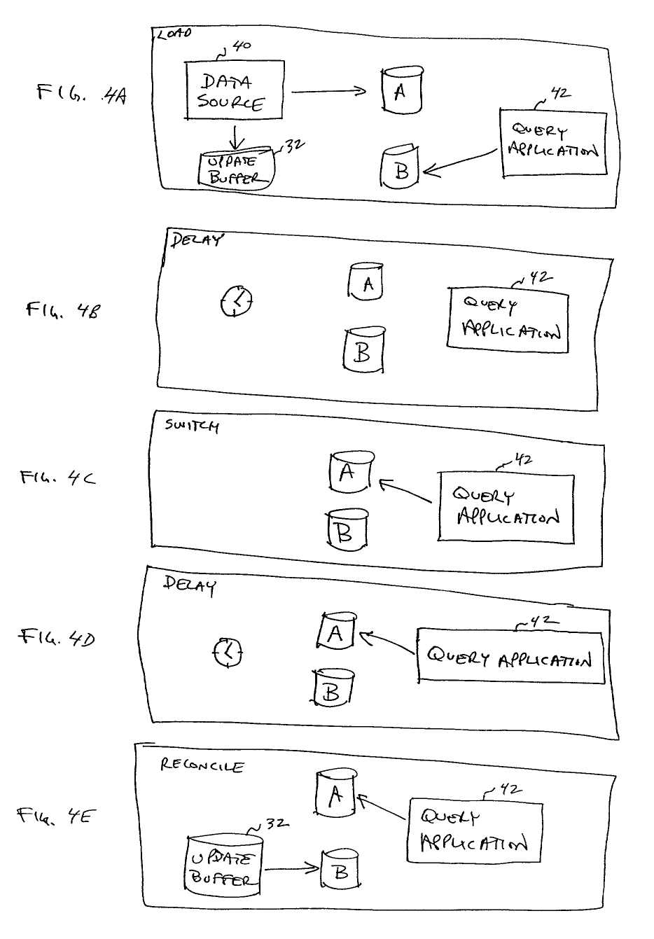

FIG. 4 is a series of block diagrams (4A, 4B, 4C, 4D and 4E) that depict various states of a live/load system during a transition. The live/load database system maintains two databases that are identical (once both are updated) through a single access point. One of the databases is always available for queries (live) by applications 42 while the other is being loaded with the most recent data (load).

In the Load state (FIG. 4A), a data source 40 loads the load database (DB A in this example) and update buffer 32. The updates to the load database can be buffered as SQL commands required to produce the same update when the other database becomes the load database.

In the next state, a delay state (FIG. 4B), the system delays a switch until all loading to the load database is complete. At the time that the live/load state is switching, there will be a point where one query is applied to one database and the next query is applied to the other database. Delay is built into the cycle to ensure that the first query is allowed to finish before operations continue on that database. This time delay can be user settable.

The next state is the Switch state (FIG. 4C), wherein the live/load state of the databases is switched so that what was the load database is now the live database. This can be done by an API or a query router directing all new connections to the new live database. The switch can be an automatic or manual process.

The next state is a delay state (FIG. 4D), where queries can occur, but no loading takes place. This delay is long enough to ensure that all connections against what was the live database, but is at this point the load database, are complete.

The final state shown in FIG. 4 is the Reconcile State (FIG. 4E) where the updates in the update buffer are applied to the database that is the load database at this point (which was the live database in the previous Load state).

There are several approaches to triggering switches, some of which are described herein. One approach is to add a trigger at the end of a job to switch at the completion of all of the relevant data flows. Another approach is to create a stand-alone job that performs the switch and schedule the job at the optimal times for the switch. Yet another approach is to allow an operator to manually switch the system.

With the application initiated switching, the application calls a function that initiates switching. This function may switch the load database to a Live Pending state (the state of the database in the delay just prior to a switch where the load database is switched to be the live database). With the next request for connection information, the state may be changed to Live if no more jobs are running. If a timeout expires and some jobs are still running, then switching is abandoned. With scheduled switching, jobs are scheduled to run at specific times and the switch is scheduled for a time when jobs are not scheduled. The time difference between load and switch times should be greater than the longest possible load plus the time for the longest possible transaction. With operator initiated switching, a system operator decides when to start the load.

### Details of an Exemplary Implementation

This section describes an exemplary implementation of a live/load database system that provides high availability. The implementation will be described with reference to applications that access databases as part of the implementation. A database management system (DBMS) provides an interface to a live database and a load database and handles which of two databases is designated the load database and which is designated the live database. The DBMS might provide this interface via an application programming interface (API) such as Visual Basic, Java (through DB layer or/with DCOM), or the like.

The DBMS may typically provide consistent access to a logical database, in that the DBMS can load and access data at the same time. One of the databases on-line (“live”), while the other is being loaded (“load”). While the load database is being loaded, all updates are buffered, so they can be later applied to the other database. More than two databases might be used, but here, the example uses only two.

Once a database is loaded successfully, a switch can take place such that the user applications are redirected to the newly loaded database and that database becomes the new live database. Meanwhile, the other database is updated (reconciled) using the buffered updates. Thus, from an application at least one database should typically be accessible through the API at any time.

As shown in FIG. 5, each database 12 has an associated control table 52. The control tables stored state information used by an API 50 to direct read only queries to the live database. Control manager 18′ maintains the correct states in control tables 52 for both databases. The API might handle all of the database traffic, or it might only handle the connection to the correct database and thereafter the application accesses the correct database directly using standard access techniques.

The control tables contain the state of the database, selected from the states: Live, Reconcile Pending, Reconcile, Load, Live Pending, Error or Manual. The control tables might also contain other information to support switching and monitoring.

A reconciliation utility may move the update data to the live database file by file or several files at a time in parallel. A Reconcile Pending timeout might be used to allow a query to finish before reconciliation starts. Without this timeout, the integrity of the live database for queries that have been started before the switch occurs cannot be fully assured.

If connection pooling takes place, connection pooling code may need to be modified to check whether the same database is still live every N minutes and if not, close the existing connections and reopen connections to the new database.

### Updates/Writes That Occur Outside Load Process

The above examples assume that the data is being queried (read) by the application and the changes to the data come from the load process. In some systems, it might be desirable to have the data modifiable by the application as well. For example, in an electronic commerce system where the application is a process that supports customer interaction, the system would accept changes from the application so that changes a user makes through the application would cause changes to the database. This is illustrated by FIGS. 6-7.

As shown in FIG. 6, an API 60 accepts writes (inserts, updates, deletes, etc.) from application 10 and applies the writes to both databases. If the same tables are changed by the application as are changed by the update process, a reconciliation process should be used to deal with updates that might overlap. For nonoverlapping tables, i.e., where the tables updated by the applications are different from tables updated by the loading processes, no reconciliation or conflict resolution is needed. However, where some of the tables updated by the applications are the same as some of the tables updated by the loading processes, there is a need to reconcile changes. Conflicts should only occur in the load database during the Reconciliation Phase and the Loading phase.

Time-stamp based conflict resolution can be used to resolve conflicts where both the application and the loader modify records in a common table. One approach is to use timestamps and always choose to keep the record with the latest timestamp. In order for this to work well, each record should have a timestamp and the systems need to have consistent clocks. Preferably, each record is uniquely identifiable by a primary key, such as a subset of columns (which might be all the columns in the table).

A reconciliation process 70 might take each record from update buffer 32 in turn and look for a corresponding record in the load database using the primary key of the record in the update buffer. If the record does not exist in the load database, the process simply inserts the record into the load database. If the record exists in the load database and its timestamp is less than or equal to the timestamp of the record from the update buffer, the record is updated in the load database. If the record exists in the load database and its timestamp is greater than the timestamp of the record from the update buffer, the update buffer record is not applied to the load database.

During the loading phase, to ensure consistency, an update process 72 extracts records from data sources and for each record a comparison is done. If the load database does not include a corresponding record (as determined by the primary key), the extracted record is inserted into the load database. If the record exists in the load database and its timestamp is less than or equal to the timestamp of the extracted record, the record in the load database is updated with the data in the extracted record. If the record exists in the load database and its timestamp is greater than the timestamp of the extracted record, the extracted record is not applied.

The above description is illustrative and not restrictive. Many variations of the invention will become apparent to those of skill in the art upon review of this disclosure. For example, while the system above is described with reference to an update process and a query process/application, the system could be used in more general settings with a write application and a read-only application, respectively. The scope of the invention should, therefore, be determined not with reference to the above description, but instead should be determined with reference to the appended claims along with their full scope of equivalents.

Appendix A. Sample SQL File Used to Buffer SQL

| | |
|---|---|
| 1 | #acta_start_transaction# |
| 2 | drop table “TESTLL1” |
| 3 | #acta_sq1_separator# |
| 4 | #acta_start_transaction# |
| 5 | create table “TESTLL1” ( “EMPNO” integer not null , “ENAME” varchar |
| 6 | (10) null , “JOB” varchar (9) null , “MGR” decimal(4, 0) null , |
| 7 | “HIREDATE” datetime null , “SAL” integer null , “COMM” integer null , |
| 8 | “DEPTNO” integer null , primary key ( “EMPNO”) ) |
| 9 | #acta_sql_separator# |
| 10 | #acta_start_transaction# |
| 11 | delete from mats_emp_empty |
| 12 | #acta_sql_separator# |
| 13 | #acta_start_transaction# |
| 14 | if exists (select 1 from “TESTLL1” where “EMPNO” = 7369 ) update |
| 14 | if exists (select 1 from “TESTLL1” where “EMPNO” = 7369 ) update |
| 15 | “TESTLL1” set “EMPNO” = 7369, “ENAME” = ‘Smith’, “JOB” = ‘Clerk’, “MGR” |
| 16 | = 7902, “HIREDATE” = ‘1980-12-17 00:00:00.00’, “SAL” = 800, “COMM” = |
| 17 | NULL, “DEPTNO” = 20 where “EMPNO” = 7369 else insert into “TESTLL1” |
| 18 | (“EMPNO”, “ENAME”, “JOB”, “MGR”, “HIREDATE”, “SAL”, “COMM”, “DEPTNO”) |
| 19 | values (7369, ‘Smith’, ‘Clerk’, 7902, ‘1980-12-17 00:00:00.00’, 800, |
| 20 | NULL, 20) if exists (select 1 from “TESTLL1” where “EMPNO” = 7499 ) |
| 21 | update “TESTLL1” set “EMPNO” = 7499, “ENAME” = ‘Allen’, “JOB” = |
| 22 | ‘Salesamen’, “MGR” = 7698, “HIREDATE” = ‘1981-02-20 00:00:00.00’, “SAL” = |
| 23 | 1600, “COMM” = 300, “DEPTNO” = 30 where “EMPNO” = 7499 else insert into |
| 24 | “TESTLL1” (“EMPNO”, “ENAME”, “JOB”, “MGR”, “HIREDATE”, “SAL”, “COMM”, |
| 25 | “DEPTNO”) values (7499, ‘Allen’, ‘Salesman’, 7698, ‘1981-02-20 |
| 26 | 00:00:00.00’, 1600, 300, 30) if exists (select 1 from “TESTLL1” where |
| 27 | “EMPNO” = 7521 ) update “TESTLL1” set “EMPNO” = 7521, “ENAME” = ‘Ward’, |
| 28 | “JOB” = ‘Salesman’, “MGR” = 7698, “HIREDATE” = ‘1981-02-22 00:00:00.00’, |
| 29 | “SAL” = 1250, “COMM” = 500, “DEPTNO” = 30 where “EMPNO” = 7521 else |
| 30 | insert into “TESTLL1” (“EMPNO”, “ENAME”, “JOB”, “MGR”, “HIREDATE”, |
| 31 | “SAL”, “COMM”, “DEPTNO”) values (7521, ‘Ward’, ‘Salesman’, 7698, ‘1981- |
| 32 | 02-22 00:00:00.00’, 1250, 500, 30) if exists (select 1 from “TESTLL1” |
| 33 | where “EMPNO” = 7566 ) update “TESTLL1” set “EMPNO” = 7566, “ENAME” = |
| 34 | ‘Jones’, “JOB” = ‘Manager’, “MGR” = 7839, “HIREDATE” = ‘1981-04-02 |
| 35 | 00:00:00.00’, “SAL” = 2975, “COMM” = NULL, “DEPTNO” = 20 where “EMPNO” = |
| 36 | 7566 else insert into “TESTLL1” (“EMPNO”, “ENAME”, “JOB”, “MGR”, |
| 37 | “HIREDATE”, “SAL”, “COMM”, “DEPTNO”) values (7566, ‘Jones’, ‘Manager’, |
| 38 | 7839, ‘1981-04-02 00:00:00.00’, 2975, NULL, 20) if exists (select 1 |
| 39 | from “TESTLL1” where “EMPNO” = 7654 ) update “TESTLL1” set “EMPNO” = |
| 40 | 7654, “ENAME” = ‘Martin’, “JOB” = ‘Salesman’, “MGR” = 7698, “HIREDATE” = |
| 41 | ‘1981-09-28 00:00:00.00’, “SAL” = 1250, “COMM” = 1400, “DEPTNO” = 30 |
| 42 | where “EMPNO” = 7654 else insert into “TESTLL1” (“EMPNO”, “ENAME”, |
| 43 | “JOB”, “MGR”, “HIREDATE”, “SAL”, “COMM”, “DEPTNO”) values (7654, |
| 44 | ‘Martin’, ‘Salesman’, 7698, ‘1981-09-28 00:00:00.00’, 1250, 1400, 30) |
| 45 | if exists (select 1 from “TESTLL1” where “EMPNO” = 7698 ) update |
| 46 | “TESTLL1” set “EMPNO” = 7698, “ENAME” = ‘Blake’,, “JOB” = ‘Manager’, |
| 47 | “MGR” = 7839, “HIREDATE” = ‘1981-05-01 00:00:00.00’“SAL” = 2850, |
| 48 | “COMM” = NULL, “DEPTNO” = 30 where “EMPNO” = 7698 else insert into |
| 49 | “TESTLL1” (“EMPNO”, “ENAME”, “JOB”, “MGR”, “HIREDATE”, “SAL”, “COMM”, |
| 50 | “DEPTNO”) values (7698, ‘Blake’, ‘Manager’, 7839, ‘1981-05-01 |
| 51 | 00:00:00.00’, 2850, NULL, 30) if exists (select 1 from “TESTLL1” where |
| 52 | “EMPNO” = 7782 ) update “TESTLL1” set “EMPNO” = 7782, “ENAME” = ‘Clark’, |
| 53 | “JOB” = ‘Manager’, “MGR” = 7839, “HIREDATE” = ‘1981-06-09 00:00:00.00’, |
| 54 | “SAL” = 2450, “COMM” = NULL, “DEPTNO” = 10 where “EMPNO” = 7782 else |
| 55 | insert into “TESTLL1” (“EMPNO”, “ENAME”, “JOB”, “MGR”, “HIREDATE”, |
| 56 | “SAL”, “COMM”, “DEPTNO”) values (7782, ‘Clark’, ‘Manager’, 7839, ‘1981- |
| 57 | 06-09 00:00:00.00’, 2450, NULL, 10) if exists (select 1 from “TESTLL1” |
| 58 | where “EMPNO” = 7788 ) update “TESTLL1” set “EMPNO” = 7788, “ENAME” = |
| 59 | ‘Scott’, “JOB” = ‘Analyst’, “MGR” = 7566, “HIREDATE” = ‘1987-04-19 |
| 60 | 00:00:00.00’, “SAL” = 3000, “COMM” = NULL, “DEPTNO” = 20 where “EMPNO” = |
| 61 | 7788 else insert into “TESTLL1” (“EMPNO”, “ENAME”, “JOB”, “MGR”, |
| 62 | “HIREDATE”, “SAL”, “COMM”, “DEPTNO”) values (7788, ‘Scott’, ‘Analyst’, |
| 63 | 7566, ‘1987-04-19 00:00:00.00’, 3000, NULL, 20) if exists (select 1 |
| 64 | from “TESTLL1” where “EMPNO” = 7844 ) update “TESTLL1” set “EMPNO” = |
| 65 | 7844, “ENAME” = ‘Turner’, “JOB” = ‘Salesman’, “MGR” = 7698, “HIREDATE” = |
| 66 | ‘1981-09-08 00:00:00.00’, “SAL” = 1500, “COMM” = NULL, “DEPTNO” = 30 |
| 67 | where “EMPNO” = 7844 else insert into “TESTLL1” (“EMPNO”, “ENAME”, |
| 68 | “JOB”, “MGR”, “HIREDATE”, “SAL”, “COMM”, “DEPTNO”) values (7844, |
| 69 | ‘Turner’, ‘Salesman’, 7698, ‘1981-09-08 00:00:00.00’, 1500, NULL 30) |
| 70 | if exists (select 1 from “TESTLL1” where “EMPNO” = 7876 ) update |
| 71 | “TESTLL1” set “EMPNO” = 7876, “ENAME” = ‘Adams’, “JOB” = ‘Clerk’, “MGR” |
| 72 | = 7788, “HIREDATE” = ‘1987-05-23 00:00:00.00’, “SAL” = 1100, “COMM” = |
| 73 | NULL, “DEPTNO” = 20 where “EMPNO” = 7876 else insert into “TESTLL1” |
| 74 | (“EMPNO”, “ENAME”, “JOB”, “MGR”, “HIREDATE”, “SAL”, “COMM”, “DEPTNO”) |
| 75 | values (7876, ‘Adams’, ‘Clerk’, 7788, ‘1987-05-23 00:00:00.00’, 1100, |
| 76 | NULL, 20) |
| 77 | #acta_sql_separator# |
| 78 | #acta_start_transaction# |
| 79 | if exists (select 1 from “TESTLL1” where “EMPNO” = 7900 ) update |
| 80 | “TESTLL1” set “EMPNO” = 7900, “ENAME” = ‘James’, “JOB” = ‘Clerk’, “MGR” |
| 81 | = 7698, “HIREDATE”, ‘1981-12-03 00:00:00.00’, “SAL” = 950, “COMM” = |
| 82 | NULL, “DEPTNO” = 30 where “EMPNO” = 7900 else insert into TESTLL1” |
| 83 | (“EMPNO”, “ENAME”, “JOB”, “MGR”, “HIREDATE”, “SAL”, “COMM”, “DEPTNO”) |
| 84 | values (7900, ‘James’, ‘Clerk’, 7698, ‘1981-12-03 00:00:00.00’, 950, |
| 85 | NULL, 30) if exists (select 1 from “TESTLL1” where “EMPNO” = 7902 ) |
| 86 | update “TESTLL1” set “EMPNO” = 7902, “ENAME” = ‘Ford’, “JOB” = |
| 87 | ‘Analyst’, “MGR” = 7566, “HIREDATE” = ‘1981-12-03 00:00:00.00’, “SAL” = |
| 88 | 3000, “COMM” = NULL, “DEPTNO” = 20 where “EMPNO” = 7902 else insert |
| 89 | into “TESTLL1” (“EMPNO”, “ENAME”, “JOB”, “MGR”, “HIREDATE”, “SAL”, |
| 90 | “COMM”, “DEPTNO”) values (7902, ‘Ford’, ‘Analyst’, 7566, ‘1981-12-03 |
| 91 | 00:00:00.00’, 3000, NULL, 20) if exists (select 1 from “TESTLL1” where |
| 92 | “EMPNO” = 7934 ) update “TESTLL1” set “EMPNO” = 7934, “ENAME” = |
| 93 | ‘Miller’, “JOB” = ‘Clerk’, “MGR” = 7782, “HIREDATE” = ‘1982-01-23 |
| 94 | 00:00:00.00’, “SAL” = 1300, “COMM” = NULL, “DEPTNO” = 10 where “EMPNO” = |
| 95 | 7934 else insert into “TESTLL1” (“EMPNO”, “ENAME”, “JOB”, “MGR”, |
| 96 | “HIREDATE”, “SAL”, “COMM”, “DEPTNO”) values (7934, ‘Miller’, ‘Clerk’, |
| 97 | 7782, ‘1982-01-23 00:00:00.00’, 1300, NULL, 10) |
| 98 | #acta_sql_separator# |

What is claimed is:

1. A computing system, wherein applications access databases to obtain data and the databases are updated from time to time and the applications require consistent data from the databases even while an update is occurring, the computing system comprising:
a first database;
a second database, wherein the first database and second database a substantive copies of each other outside of an update period;
a database indicator that indicates one of the first and second databases as a live database and the other one of the first and second databases as a load database;
a query router for routing queries from application to the live database; and
a router switcher for switching the database indicator such that the live database becomes the load database and the load database becomes the live database.

2. The computing system of claim 1, wherein the queries from an application to the live database are in the form of SQL queries.

3. The computing system of claim 1, further comprising an update router for routing updates from an updater to the load database.

4. The computing system of claim 3, wherein the updates from an updater to the load database are in the form of SQL statements.

5. The computing system of claim 1, further comprising an update cache that stores updates from the updater including logic to initiate update of the live database with the stored updates when the live database becomes the load database.

6. A method for providing consistent information from a database
management system comprising a plurality of databases, comprising:
receiving a request for a first information item by said database management system;
processing said request by a first database of said database management system, when said request is for a read operation;
processing said request by a second database of said database management system, when said request is for a write operation; and
following a database update period, switching the roles of the first database and the second database such that the database that processed reads then processes writes and the database that processed writes then processes reads.
